(19) United States
(12) Patent Application Publication
(10) Pub. No.: US 2013/0218875 A1
(43) Pub. Date: Aug. 22, 2013

(54) TABLE-DRIVEN ENTERPRISE-WIDE DATA INTEGRATION

(71) Applicant: B. Victor Carriri, Casa Grande, AZ (US)

(72) Inventor: B. Victor Carriri, Casa Grande, AZ (US)

(21) Appl. No.: 13/854,645

(22) Filed: Apr. 1, 2013

Related U.S. Application Data
(63) Continuation-in-part of application No. 13/020,690, filed on Feb. 3, 2011.

(51) Int. Cl. G06F 17/30

(52) U.S. Cl. CPC G06F 17/30557
USPC 707/722

(57) ABSTRACT

A master database is consulted for records containing a set of instructions and business rules pertaining to the data integration tasks to be performed when the system is run. Detail records are retrieved with the detailed steps to be performed. The actual data integration is accomplished by calls to various software modules which perform one or more basic function necessary for the data integration. Such an approach makes it easier to set up, maintain and change the data integration, and does not require custom coding which tends to be error prone and costly to implement and to maintain.

### CROSS-REFERENCE TO RELATED APPLICATIONS

This application is a continuation-in-part of pending application Ser. No. 13/020,690 to B. Victor Cariri, filed on Feb. 2, 2012, the subject matter of which is incorporated herein by reference.

### BACKGROUND OF THE INVENTION

1. Field of the Invention

The present invention relates to a table-driven method and system for enterprise-wide data integration.

2. Description of the Related Art

As business has become increasingly dependent upon technology for efficient function, a variety of computer and software systems have been developed. Major enterprise systems such as Enterprise Resource Planning (ERP), Customer Relationship Management (CRM), and Product Lifecycle Management (PLM) have aided businesses in specific areas. However, each has been developed using a unique database structure, which has made it difficult for such systems to effectively share data. For example, where data is added or changed in one system the addition or change may need to be reflected in one or more other system. However, such enterprise-wide data integration has been difficult and costly to accomplish.

To resolve the issue, companies have resorted to the creation of custom software solutions or highly customized software packages to integrate these enterprise datasets. These systems have been time consuming to create or implement (often taking in excess of six months), as well as expensive (often costing in excess of $100,000). In addition, these systems have been heavily dependent on custom code, which leaves them highly susceptible to failure in the (common) event of a data structure change with an upgrade of an enterprise system. This can result in serious financial harm to a business as it tries to repair the broken integration system(s). As an example, Oracle's Siebel CRM made a highly invasive data structure change in the upgrade from Siebel Version 6 to Version 7. According to an article published in a trade magazine, the “botched upgrade” cost a major wireless communication company an estimated $100 million in lost revenue as well as several thousand customers.

The most recent trend is to create and market “connectors” that purport to facilitate the integration of one specific pairing of enterprise systems. They may help to some degree, but lack any flexibility, not designed to integrate any other pairings of systems. These will be susceptible to the same weaknesses as fully custom integration applications.

Several patents have been issued which employ the term “data integration”. However, these patents merely involve unilateral transfer of data between a data source and a data destination. There is no disclosure of a process wherein a record is inserted into the data destination in response to a change or addition of a record in the data source. As an example, U.S. Pat. No. 7,650,608 to Patel et al. entitled “System and Method for Application and Resource Data Integration” describes a system and method that allows a second system to use data from a first system wherein the first system exports data in a standard XML format which is then imported into the second system.

### SUMMARY OF THE INVENTION

The term data integration includes the ability to detect relevant changes in information and process updates wherever desired throughout an organization. As used herein the term business rules can include rules such as order of processing, mapping of data between records having different formats and stored in different databases, which data will prevail when two data stores hold differing information, whether specific data should be updated at the destination, and so forth. The term table-driven data integration refers to the use of tables to store the business rules and instructions to accomplish the data integration.

In an embodiment, a master database is consulted for records containing a set of instructions and business rules pertaining to the data integration tasks to be performed. Detail records are retrieved with the steps to be performed. The actual data integration is accomplished by calls to various software modules which perform one or more basic function necessary for the data integration. Such an approach makes it easier to set up, maintain and change the data integration, and does not require custom coding which tends to be error prone and costly to implement. The software modules retrieve needed parameters from the database to accommodate the configured process of the function. An adjustment to a process merely requires an edit to the parameters in the database table, no changes to software code or custom scripting.

One aspect of the disclosure relates to a data integration system, comprising a data integrator in communication with at least a first data store and a second data store. The data integrator is configured to (a) obtain a set of records including instructions for performing data integration with respect to the first data store and the second data store; and (b) effect the data integration in accordance with the instructions. The set of records is retrieved from a relational database. The first data store and the second data stores are typically relational databases; however the same process could be used if source or destination system holds data in an alternative data store, such as XML. The set of records includes information regarding a set of data integration tasks to be performed by calling a plurality of software modules. In an embodiment, the data integration can be scheduled, so that the set of records are retrieved according to a run frequency. The set of tasks can include detecting data in the first data store for addition or update to corresponding data in the second data store. The detection of changed or new data in the first data store can be accomplished by comparing current data of the first data store with historical data. Because a change or addition to certain fields may not matter, a list of fields to ignore in the comparison can be established. As an example, in business context, a CRM will likely be deemed to hold the most up to date sales contact info, so a change to a sales contact record in the ERP might be configured to be ignored in the data integration process. The data integration can include mapping data fields of records of the first data store to data fields of records of the second data store; detecting changed or new records of the first data store; for each records detected as changed or added, copying data of the first data store to an import table, according to the mapping; and importing the data of the import table to the second data store. The data integration can be unidirectional or bidirectional. The data integrator can be advantageously configured to be in communication with additional data stores and provide data integration thereto, so that the entire organization can achieve a high level of data sharing and data consistency.

### BRIEF DESCRIPTION OF THE DRAWINGS

FIG. 1 is a block diagram illustrating a data integration server for data integration among enterprise systems, according to an embodiment of the present invention;

FIG. 2 is a block diagram illustrating exemplary data integration modules which perform basic functions of one or more data integration;

FIG. 3 is a network diagram illustrating an example implementation of the data integration server of FIG. 1 for a particular organization, according to an embodiment of the present invention;

FIG. 4 illustrates an example database schema for the data integration implementation;

FIG. 5 is a flow chart illustrating a technique for table-driven data integration, according to an embodiment of the present invention; and

FIG. 6 illustrates an example graphical user interface (GUI) for field mapping useable in conjunction with an embodiment of the present invention.

### DETAILED DESCRIPTION OF THE INVENTION

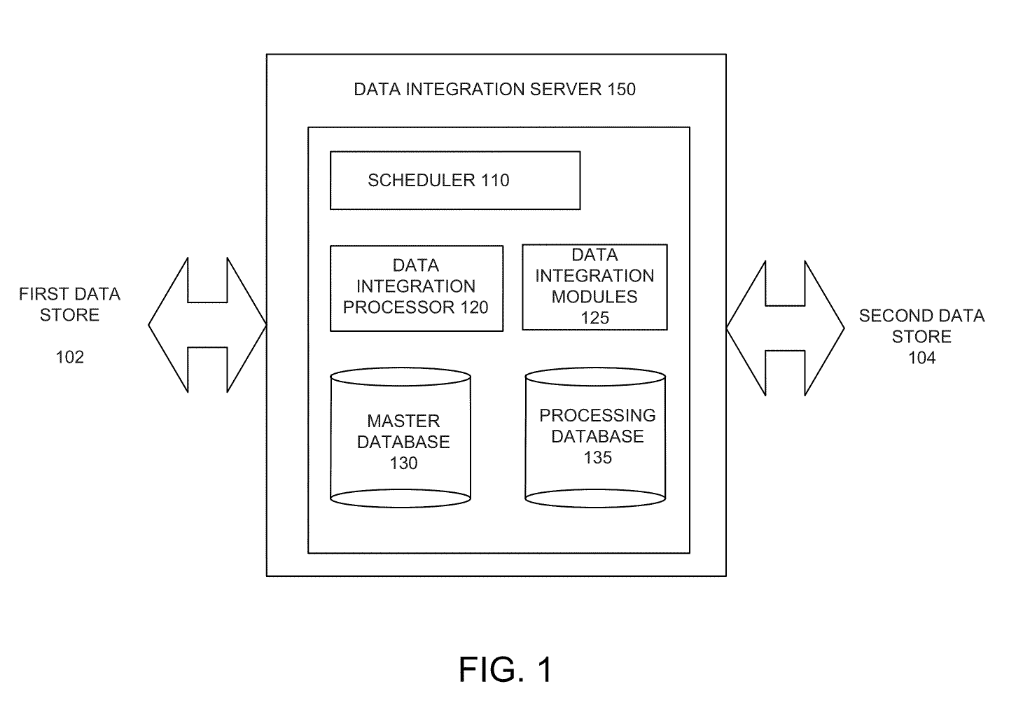

Referring to FIG. 1, an exemplary Data Integration Server 150 for data integration, according to an embodiment of the present invention, is shown. For illustrative purposes, only two data stores are illustrated. However, it is to be understood that the Data Integration Server 150 could accommodate many more data stores. As shown, the Data Integration Server 150 includes a Scheduler 110, a Data Integration Processor 120, Data Integration Modules 125, a Master Database 130, and a Processing Database 135. The Scheduler 110 can include any suitable job scheduler software to schedule data integration tasks to be performed by the Data Integration Processor 120. The Data Integration Modules 125 includes software of the invention which performs basic functions as requested by the Data Integration Processor 120, and interact with the Master Database 130 and the Processing Database 135, as needed. The Master Database 130 includes configuration data and the business rules for all data integrations to be processed. The Processing Database 135 includes a database that contains the data used for identifying new and updated records and integrating the data.

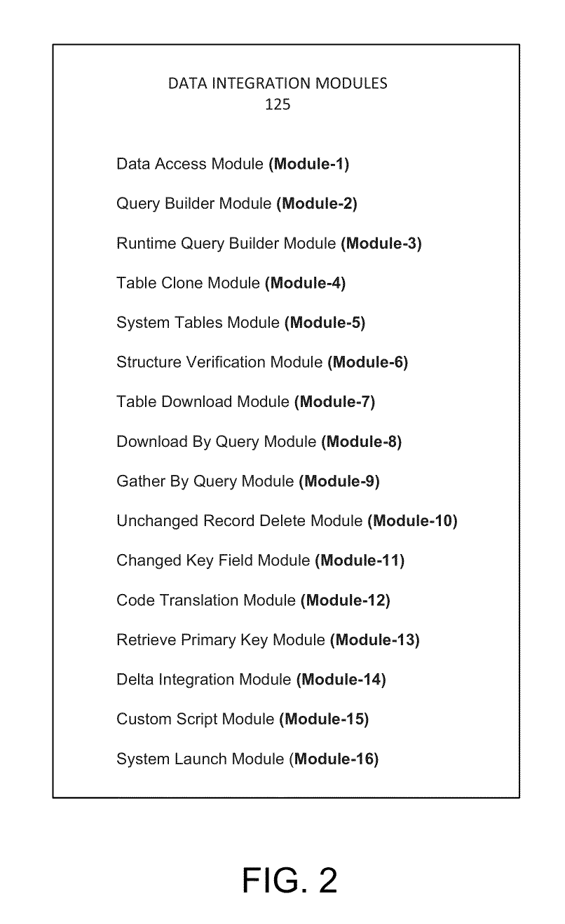

Referring to FIG. 2, the Data Integration Modules 125, which perform the specific functions as requested by the Data Integration Processor 120, are shown. It is to be understood that other architectures to accomplish the same or substantially similar processing could be used; thus, the following description is not meant to be limiting.

### Data Integration Modules 125

Module-1. Data Access Module

The Data Access Module is used to obtain information (which is stored in the Master Database 130) to prepare various data connections, e.g., server name, database name, login user id/password, workspace name. The Data Access Module can also contain tools to gather data regarding database tables, fields, and records.

Module-2. Query Builder Module

The Query Builder Module provides a graphical user interface (GUI) for creating SQL queries. In the context of data integration, the Query Builder Module can be used to build a complex query that brings together all of the information from a normalized relational database about an entity. For illustrative purposes, Microsoft Access provides a suitable Query Builder plug-in. Desirable features include easy access to edit the SQL statements generated and the ability for the generated SQL statement to be saved.

Module-3. Runtime Query Builder Module

The Runtime Query Builder module dynamically builds insert and update queries to ensure that the destination database 104 reflects changes detected in the Source Database 102.

Module-4. Table Clone Module

Because of limitations on directly performing certain database commands (such as a join query) in various database systems, it is necessary to download a copy of a table so that operations can be performed locally. The Table Clone module is used to read a table in either the Source Database 102 or the Destination Database 104, and create a copy of the table which is then stored in the Processing Database 135.

Module-5. System Tables Module

The System Tables module reads the Source Database 102 and the Destination Database 104 and automatically creates system tables within the Processing Database 135 to use in subsequent data integrations. These system tables include Working Tables which reflect the current state of the Source Database 102 and History Tables which reflect the last-run state of the Source Database 102.

Module-6. Structure Verification Module

The Structure Verification module is used to verify data structures in both the source database and destination database to ensure all tables and fields in the working and history tables are kept up to date. As an example, where a new field for ‘country code’ is added to a customer record, this field will be added automatically to the data structures of the appropriate working and history tables. Fields no longer found in a destination table fall into two categories. If the field is not mapped in the field mapping table to a source field, it can be deleted, and the user notified. If the field is mapped in the field mapping table to a source field, the user should be notified and the process halted for resolution. Emails can be automatically sent to an administrator in these cases, especially if the system is halted because of a preconfigured, but now missing, destination field.

Module-7. Table Download Module

The Table Download module deletes all records from a pre-existing clone table in the Processing Database 135 and retrieves the current records.

Module-8. Download By Query Module

Where the data can be retrieved directly, the Download by Query module retrieves current data from the source database 102 via an SQL query and loads this data into the appropriate working table.

Module-9. Gather By Query Module

Where the data cannot be retrieved directly (because of database limitations), the Gather by Query module is used to retrieve the current data from cloned tables located in the Processing Database 135 via an SQL query and load this data into the appropriate working table.

Module-10. Unchanged Record Delete Module

The Unchanged Record Delete module removes records from the working tables that have not been changed in configured fields to update since the last data integration was run. This is accomplished by comparing each working table with its corresponding history table. Where a record is found that matches (i.e., a designated field such as ‘account number’, or combination of fields, matches), the record is deleted from the working table. After this process is performed, the working table contains records which reflect newly added or changed information which should be incorporated into the Destination Database 104.

Module-11. Changed Key Field Module

The Changed Key Field module is necessitated by poor database design. It is used to update a poorly designed primary key in a destination table.

Module-12. Code Translation Module

The Code Translation module translates data fields in the newly downloaded data of the working table into the code as found for that field in the tables of the destination database 104. For example, where an import table used to update the Destination Database 104 requires a value (e.g., a numeric code) different from the value found for the field in the Source database 102 (e.g., an alphanumeric description), the Code Translation module would translate the value found in the source database 102 to the value needed for the import table.

Module-13. Retrieve Primary Key Module

The Primary Key module is used to get a new primary key record from the Destination Database 104 for use in the creation of a new record for insert into the Destination Database 104.

Module-14. Delta Integration Module

The Delta Integration module is used to process the newly downloaded data in the working tables, detect new records and updated records from the Source Database 102, create records for inserting into import tables of the Destination Database 104 or inserting or updating the records directly in the final destination tables of the Destination Database 104 as required by the destination system architecture.

Module-15. Custom Script Module

While a primary goal of the present invention is to eliminate custom scripting, the need may arise for limited use of custom scripts. As with our other functionality, the script will be stored in a database, but a flexible Custom Script Module can be used to run the custom scripts.

Module-16. System Launch Module

The System Launch module is used to launch the import processes of the destination database 104.

In the forgoing description, exemplary modules for performing various aspects of the present invention are disclosed. It is to be understood that these modules can be created using computer program code written in a variety of suitable programming languages, such as C, C++, C#, Visual Basic, and Java. It is to be understood that the software of the invention can be stored as machine-readable code on a non-transitory storage medium, and loaded into internal computer memory when needed, as is known in the art.

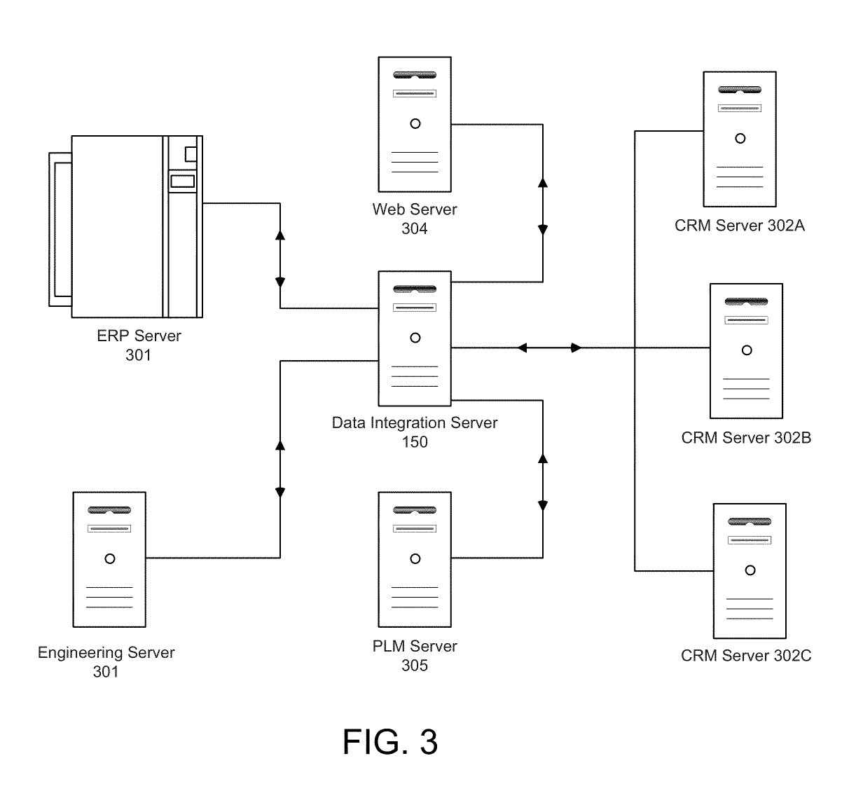

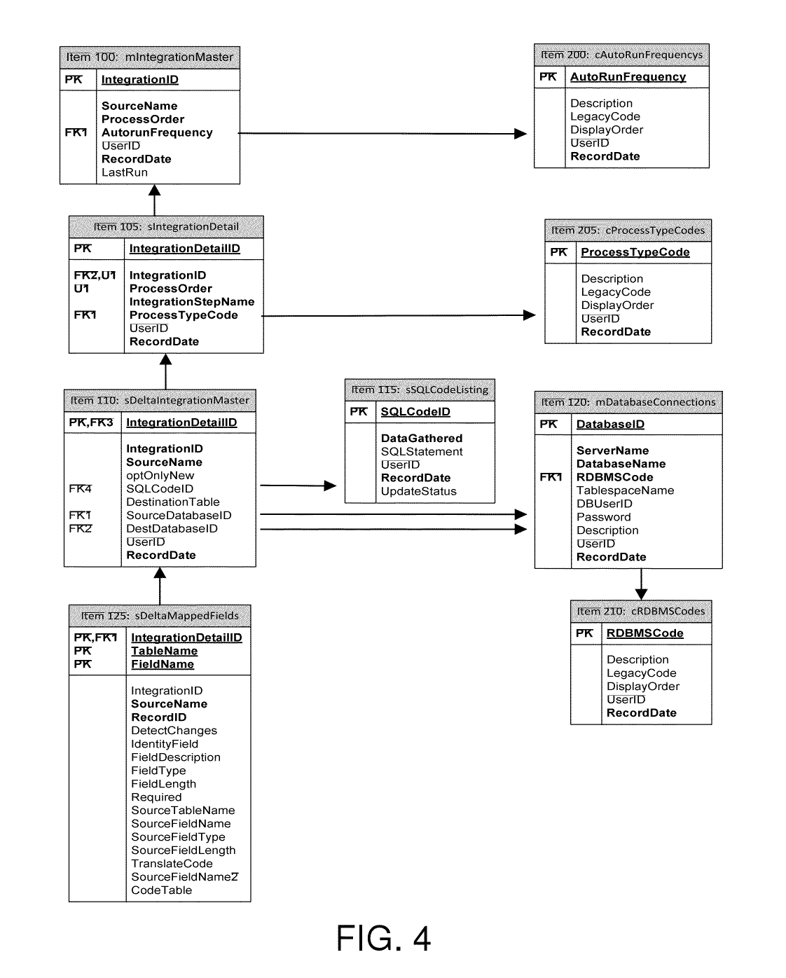

FIG. 3 illustrates a network diagram of an example implementation of the data integration server 150 for a particular organization, according to an embodiment of the present invention. FIG. 4 illustrates an example database schema for the data integration. For the working example, the company has an enterprise resource planning (ERP) server 301 running on an IBM midrange computer using a normalized data structure in its data files. The ERP utilizes Report Program Generator (RPG), a high-level programming language for business applications. The company is also running a Windows customer relationship management (CRM) system using a normalized Oracle database, components and databases found in CRM Servers 302A-C. Additionally, the company has other database systems, namely, a Web Server 304, a Product Lifecycle Management (PLM), and an Engineering Server 301. However, the following example focuses on data integration between the ERP Server 301 and the CRM Servers 302A-C systems.

The Data Integration Server 150 provides the data integration and runs the Data Integration Processor 120, and an SQL server running the Master Database 130 and the Processing Database 135. For the sake of the discussion, it is assumed that open database connectivity (ODBC) connection will not allow a joined query to be submitted directly to the source database.

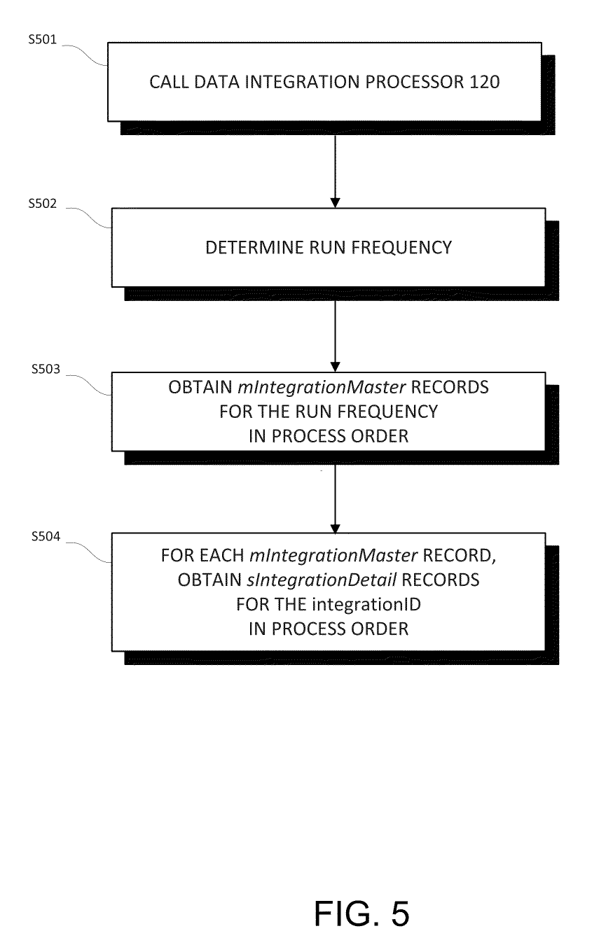

Referring to FIG. 5, a flowchart of a method for table-driven data integration, according to an embodiment of the present invention, is illustrated.

Initially (Step S501), the Scheduler 110 calls the Data Integration Processor 120.

Then (Step S502), the Data Integration Processor 120 accesses a built-in time/date module for calendar and time information (or otherwise obtains this information) to determine what type of data integration should be performed. The type of data integration will generally be based on the run frequency (e.g., daily, weekly, one-time) for particular data integrations. For the sake of the discussion, assume that the Data Integration Processor 120 has determined that only daily data integrations should be performed. Assume further that a code is used to designate the different run frequencies, and that the Data Integration Processor 120 determines that the code (called the AutoRunFrequency code) for daily runs is “1”.

Then (Step S503), rather than looking at local source code, the Data Integration Processor 120 selects a table mIntegrationMaster (see schema diagram; FIG. 4) (in the Master Database 130) for the tasks for the “daily” data integration. The mIntegrationMaster table is ordered according to the field ProcessOrder. Accordingly, the Data Integration Processor 120 executes an SQL select command against the mIntegrationMaster table to obtain, in ProcessOrder, records where AutoRunFrequency is equal to ‘1’. After the select command is executed, records from the mIntegrationMaster table are obtained representing the tasks to be performed. Each task is assigned a unique identifier called the IntegrationID. In the example, the IntegrationID is a two-digit numeric. Suppose that two records are returned in ProcessOrder ascending having the following IntegrationID's: ‘23’ and ‘27’. Assume that that IntegrationID ‘23’ refers to the data integration task of updating the CRM with new and updated customer companies and IntegrationID ‘27’ refers to the task of updating the CRM with new and updated sales orders. (Note that in this example, the order matters since the second task may require existing company information in the CRM).

Then (Step S504), for each mIntegrationMaster record, a set of sIntegrationDetail records are obtained for the IntegrationID in process order. The first integration is to update the CRM with new and updated customer companies. To obtain the sequence of steps to accomplish this, a call is made to the table sIntegrationDetail for the steps needed to accomplish the IntegrationID ‘23’. Each sIntegrationDetail record includes a code called the IntegrationDetailID which identifies the specific Data Integration Module(s) 125 to be called. These steps would normally be found in custom code for the software, but with a table-driven, data-driven system, these steps, comprising a section of the data integration system logic, will be determined during runtime based on parameters recovered from tables. (Note: throughout this sequence, calls can be made to the Structure Verification Module (Module-6) to verify that the data structures for the tables found in the Processing Database 135 correspond properly to the source and destination tables in the source and destination databases. However, the example described herein is simplified to exclude this detail. Other detail such as calls to the Data Access Module (Module-1) to obtain access information user id/passwords, etc., the use of the Query Builder Module (Module-2) to construct complex SQL statements, and use of the Changed Primary Key module and the Code Translation module are also not in the example for the sake of simplicity.)

For a relatively simple source database structure and destination database structure, there might only be a few steps in the data integration process. For the working example, one of medium complexity, let's suppose that the following records are returned in ProcessOrder ascending, with a total of seven (7) steps for the entire integration:

Data Integration Step 1: IntegrationID 23, IntegrationDetailID 721: Download DataFile1 from the Source Database (ERP Server 301). The processor calls the Table Download Module (Module-7) with the data file name ‘DataFile1’.

Data Integration Step 2: IntegrationID 23, IntegrationDetailID 932: Download DataFile2 from the Source Database (ERP Server 301). The processor calls the Table Download Module (Module-7) with the data file name ‘DataFile2’.

Data Integration Step 3: IntegrationID 23, IntegrationDetailID 1723: Download DataFile3 from the Source Database (ERP Server 301). The processor calls the Table Download Module (Module-7) with the data file name ‘DataFile3’.

Data Integration Step 4: IntegrationID 23, IntegrationDetailID 23: Download DataFile4 from the Source Database (ERP Server 301). The processor calls the Table Download Module (Module-7) with the data file name ‘DataFile4’.

Data Integration Step 5: IntegrationID 23, IntegrationDetailID 91: Gather customer company data by joined query from the Processing Database 135 from DataFile1, DataFile2, DataFile3, DataFile4. The Data Integration Processor 120 calls the Gather By Query Module (Module-9) with the parameter, IntegrationDetailID 91. The Gather By Query Module (Module-9) retrieves the destination table name and the SQLCodeID ‘21’ from sDeltaIntegrationMaster, then reads the SQL query code from the table sSQLCodeListing by the SQLCodeID. The “Working Table” in the Processing Database is purged. The Gather By Query Module (Module-9) executes the code to populate the Working Table which has the same structure as the destination table. After the Working Table is populated with the current data the system is ready for the next step, the detection of new and changed records by comparison of the Working Table and the History Table, and thereby prepares the data for the actual data integration to take place.

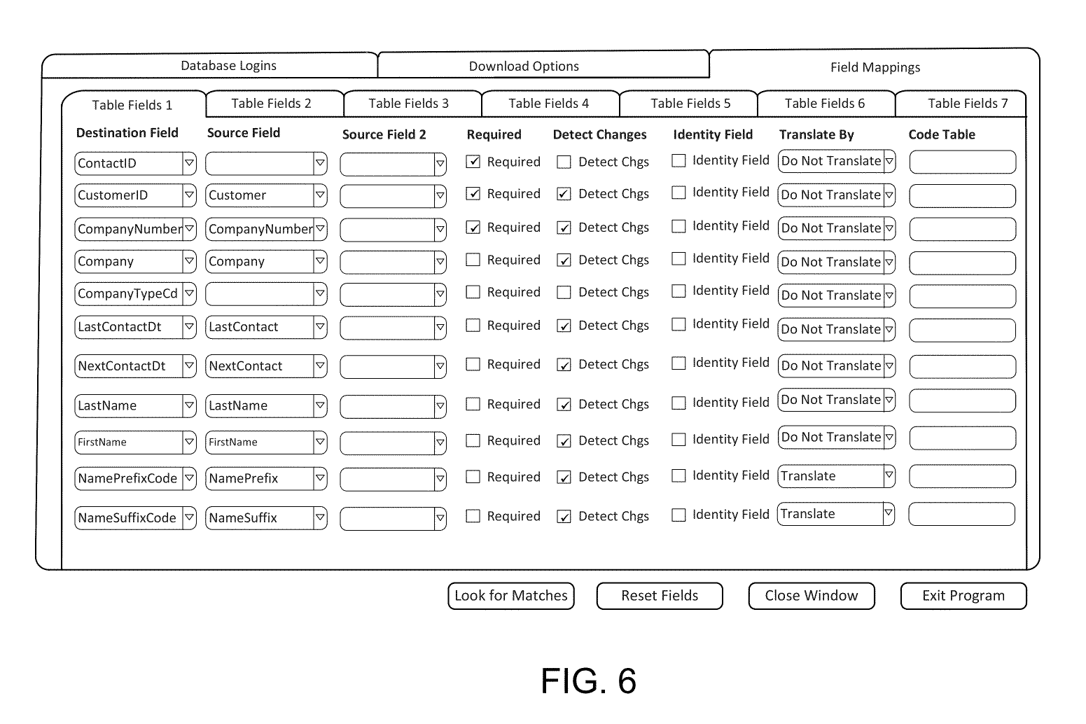

Data Integration Step 6: IntegrationID 23, IntegrationDetailID 1972: The Data Integration Processor 120 calls the Delta Integration Module (Module-14) which now has access to the current and (from the last run) the historical Customer Account data ready in the Working Table and the History Table, respectively, for the detection of new and (if configured) changed records for the integration. The table DeltaMappedFields holds the parameters to enable the system to determine logic and business rules for the integration on a detail level runtime. Records that have the same information in the Working Table as in the History Table will be deleted and ignored. Note: a field called DetectChanges is provided such that if that field value is ‘false’, a record with only this field changed is treated as unchanged. (Note also that changed values in fields with a DetectChanges value is ‘false’ the changed values in that field will be ignored as other fields are updated by the processor.) (See FIG. 6 for an example screen for inputting mapping information and specifying whether to detect changes for particular fields). The Delta Integration Module (Module-14) calls the Unchanged Record Delete Module (Module-10) to remove unchanged records. Then, the Delta Integration Module (Module-14) uses the detail information in sDeltaMappedFields to construct the SQL statements to write the new Customer Account records into the destination database table for import, and into the History Table. Once again, the Delta Integration Module (Module-14) calls the Unchanged Record Delete Module (Module-10) to remove unchanged records. This time the records that will be removed from the Working Table will be the new records that have just been prepared for import by the CRM's processor. If this process is run for an initial data load for the implementation of a new system or for a data warehousing purpose, all records will have been truncated, so the process is done. This process will also be complete here if the selection of the integration type is to migrate new records only. Any records remaining in the Working Table of the Processing Database are records that have been updated in the Source Database. Then the Delta Integration Module (Module-14) will again use the detail information in sDeltaMappedFields to construct the SQL statements to write the updated Customer Account records into the destination database table for import, and into the History Table.

Data Integration Step 7: Since the destination CRM requires the use of its internal import processor and provides the import tables that must be used to add new records and update existing records, the final step the processor makes is to call the System Launch Module (Module-16) to launch the import process within the destination system.

Once this step is complete, the data is integrated from source to destination databases. The Data Integration Processor 120 moves on to the next data set to integrate, in the example given, IntegrationID27: Update the CRM with new and updated sales orders. This data integration may require more or fewer steps, involve more than one destination table, and so forth. The logic and the rules will follow the steps as located in the sIntegrationDetail for IntegrationID27.

After the Data Integration Processor has sequentially executed the steps required in the mIntegrationMaster and sIntegrationDetail, the data integration processing is complete. This can result in a unidirectional integration of just two enterprise systems, or, depending on the configuration data found in the Master Database 130, can potentially result in a combination of unidirectional and bidirectional integrations of any number of enterprise systems.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A data integration system, comprising:
a first data store;
a second data store; and
a data integrator, the data integrator in communication with the first data store and the second data store and configured to
(a) obtain a set of records including instructions for performing data integration with respect to the first data store and the second data store; and
(b) effect the data integration in accordance with the instructions.

2. The data integration system of claim 1, wherein the set of records is retrieved from a third data store, the third data store a relational database.

3. The data integration system of claim 2, wherein the first data store and the second data stores are relational databases.

4. The data integration system of claim 1, wherein the set of records includes information regarding a set of data integration tasks to be performed.

5. The data integration system of claim 4, wherein the data integrator is further configured to call a plurality of software modules to perform the tasks.

6. The data integration system of claim 1, wherein the set of records is retrieved according to a run frequency.

7. The data integration system of claim 2, wherein the set of tasks includes detecting data in the first data store for addition or update to corresponding data in the second data store.

8. The data integration system of claim 7, wherein the detecting includes comparing current data of the first data store with historical data of the first data store.

9. The data integration system of claim 8, wherein the detecting includes ignoring specified data fields of records of the first data store.

10. The data integration system of claim 2, wherein the set of records further includes detail records having instructions as to the steps to be performed to accomplish the tasks.

11. The data integration system of claim 10, wherein the detail records are retrieved in process order.

12. The data integration system of claim 11, wherein identifiers are assigned to each of the tasks and the task steps.

13. The data integration system of claim 1, wherein the data integration includes
mapping data fields of records of the first data store to data fields of records of the second data store;
copying data of the first data store to an import table, according to the mapping; and
importing the data of the import table to the second data store.

14. The data integration system of claim 1, wherein the data integration is unidirectional.

15. The data integration system of claim 1, wherein the data integration is bidirectional.

16. A method for performing data integration, comprising:
establishing a connection with a first data store;
establishing a connection with a second data store;
obtaining a set of records regarding performing data integration with respect to the first data store and the second data store, wherein the set of records includes instructions regarding a set of data integration tasks to be performed in a predetermined order; and
executing a plurality of modules in accordance with the instructions to perform the tasks.

17. The method of claim 16, wherein the first data store and the second data stores are relational databases.

18. The method of claim 17, wherein the set of tasks includes detecting data in the first data store for addition or update to corresponding data in the second data store.

19. The method of claim 18, wherein the detecting includes comparing current data of the first data store with historical data of the first data store.

20. A physical non-transitory computer readable medium comprising computer executable instructions stored on the physical non-transitory computer readable medium that when executed by one or more computer processor cause the one or more processor to perform the following: obtain a set of records regarding performing data integration with respect to a first data store and a second data store, wherein the set of records includes instructions regarding a set of data integration tasks to be performed in a predetermined order; and execute of a plurality of modules in accordance with the instructions to perform the tasks.
